(19) United States
(12) Patent Application Publication
(10) Pub. No.: US 2018/0344552 A1
(43) Pub. Date: Dec. 6, 2018

(54) Bed Rest System

(71) Applicants: Abdul Bakarr Kamara, Miami, FL (US); Helena Fatimata Kamara, Miami, FL (US)

(72) Inventors: Abdul Bakarr Kamara, Miami, FL (US); Helena Fatimata Kamara, Miami, FL (US)

(21) Appl. No.: 16/059,514

(22) Filed: Aug. 9, 2018

Related U.S. Application Data
(60) Provisional application No. 62/544,373, filed on Aug. 11, 2017.

(51) Int. Cl. A61G 7/10; A61G 7/057

(52) U.S. Cl. CPC A61G 7/103; A47C 27/148; A61G 7/057

(57) ABSTRACT

A bed rest system for improving health of immobile patients and safety of the patients' caretakers. The system includes a mattress cover and a transfer board. The mattress cover is configured to prevent or ameliorate health complications of a patient that may arise because of bed rest. The transfer board is configured to facilitate easy and safe transfer of a patient from one surface to another surface by one or more caretakers. During use, the mattress cover conforms to a patient's body and does not cause indentations in the skin, thereby preventing or ameliorating bedsores. During use, the transfer board is secured on a crevice between two surfaces, such as beds, and prevents or reduces a risk of the patient falling between the beds during transfer of the patient from one bed to the other bed. The complete system may be used, or either the mattress cover or the transfer board may be used individually.

### CROSS REFERENCE TO RELATED APPLICATIONS

This application claims priority under 35 U.S.C. § 119(e) to U.S. Provisional Application No. 62/544,373 filed on Aug. 11, 2017. The above identified patent application is incorporated by reference herein in its entirety to provide continuity of disclosure.

### BACKGROUND OF THE INVENTION

The present invention relates to a modular bed rest system.

Bed rest is commonly employed in health care facilities as part of treatment, but this practice may risk health of a patient and safety of a patient's caretakers. For example, the patient may develop bedsores, decubitus ulcers, infections such as nosocomial infections, or other illnesses if the patient is unable to mobilize frequently (e.g., if the patient is critically ill, elderly, obese, or handicapped), and the caretakers may accidentally injure themselves or the patient during care activities, including transfer of the patient between beds or other surfaces. Accidents that may occur include, but are not limited to, the patient falling between beds, between operation tables, or between other surfaces during transfer of the patient from one surface to another by the caretakers, bumping the patient's hip or shoulder against the receiving surface, muscle strain on the patient's caretakers, and causing discomfort for the patient during the transfer.

Therefore, there is a need in the art for a bed rest system for improving health and safety of both patients and caretakers when a patient is immobilized or confined to bed rest. The present invention addresses this unmet need.

Systems have been disclosed in the art that relate to bed rest. These include items that have been patented and published in patent application publications. These devices are insufficient because they do not treat or prevent diseases or disorders resulting from bed rest, nor do they facilitate safe transfer of a patient between surfaces. In view of the systems disclosed in the art, it is submitted that there is a need in the art for an improvement to existing bed rest systems. In view of the present disclosure, it is submitted that the present invention substantially diverges in structural and functional elements from devices and methods in the art, and the present invention substantially fulfills an unmet need in the art.

### SUMMARY OF THE INVENTION

In view of the disadvantages inherent in the known types of bed rest systems in the art, the present invention provides a new and improved bed rest system, wherein the same can be utilized for providing safety and health to a patient, and for providing safety and convenience to one or more caretakers.

It is therefore an object of the present invention to provide a modular bed rest system.

Another object of the present invention is to provide a mattress cover that treats or prevents a disease or disorder associated with bed rest.

Yet another object of the present invention is to provide a transfer board that facilitates safe transfer of a patient between surfaces.

Another object of the present invention is to provide a system comprising the mattress cover and the transfer board, to be used together as a system for providing safety and health to a patient, and for providing safety and convenience to one or more caretakers.

In one aspect, the invention provides a bed rest system, comprising a mattress cover having a mattress cover bottom layer, a mattress cover middle layer disposed on an upper surface of the mattress cover bottom layer, and a mattress cover top layer disposed on an upper surface of the mattress cover middle layer. The mattress cover bottom layer includes a material that is durable and slippery; the mattress cover middle layer includes a material that is moderately firm; and the mattress cover top layer includes a material that is durable and stain resistant.

In another aspect, the invention provides a bed rest system, comprising a transfer board having a main board, a first side board, and a second side board. The first side board is connected to a first side of the main board, and the second side board is connected to a second side of the main board, such that the first side of the main board is opposite to the second side of the main board. The transfer board includes a material that is durable and slippery, and the transfer board includes at least one stabilizing fin extending perpendicularly downward from a bottom side of the transfer board.

In another aspect, the invention provides a bed rest system, comprising the mattress cover and the transfer board. The system can be utilized to improve health and safety of bed rest, including when a patient is resting stationary on the mattress cover, and when a patient is being transferred between two resting surfaces using the transfer board, optionally in combination with the mattress cover. In various embodiments, the patient rests on the mattress cover before, during, and after transfer of the patient between two resting surfaces using the transfer board. Generally, the mattress cover is configured to easily slide on the transfer board, facilitating safe transfer of the patient from a first resting surface to a second resting surface. In various embodiments, the transfer board is configured to be stationary and hold firmly to two surfaces, such as two beds, thereby preventing or reducing a risk of the patient falling between the beds during transfer.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a perspective view of an exemplary embodiment of a mattress cover.

FIG. 2 depicts a side perspective view of the exemplary embodiment of the mattress cover.

FIG. 3 depicts a perspective view of an exemplary embodiment of a transfer board.

FIG. 4 depicts a side perspective view of the exemplary embodiment of the transfer board.

FIG. 5 depicts a top perspective view of the exemplary embodiment of the mattress cover used in combination with the exemplary embodiment of the transfer board, showing a patient resting on the mattress cover set atop a first surface (left bed) that is bridged to a second surface (right bed) by the transfer board, an initial position before transfer of the patient.

FIG. 6 depicts a top perspective view of the exemplary embodiment of the mattress cover used in combination with the exemplary embodiment of the transfer board, showing the patient resting on the mattress cover set atop the transfer board that is bridging the first surface (left bed) to the second surface (right bed), an intermediate position during transfer of the patient.

FIG. 7 depicts a top perspective view of the exemplary embodiment of the mattress cover used in combination with the exemplary embodiment of the transfer board, showing the patient resting on the mattress cover set atop the second surface (right bed) that is bridged to the first surface (left bed) by the transfer board, a final position after transfer of the patient.

### DETAILED DESCRIPTION OF THE INVENTION

Reference is made herein to the attached drawings. Like reference numerals are used throughout the drawings to depict like or similar elements of the system. The figures are intended for representative purposes only and should not be considered limiting in any respect.

Reference is now made to the drawings, which depict one or more exemplary embodiments of the invention.

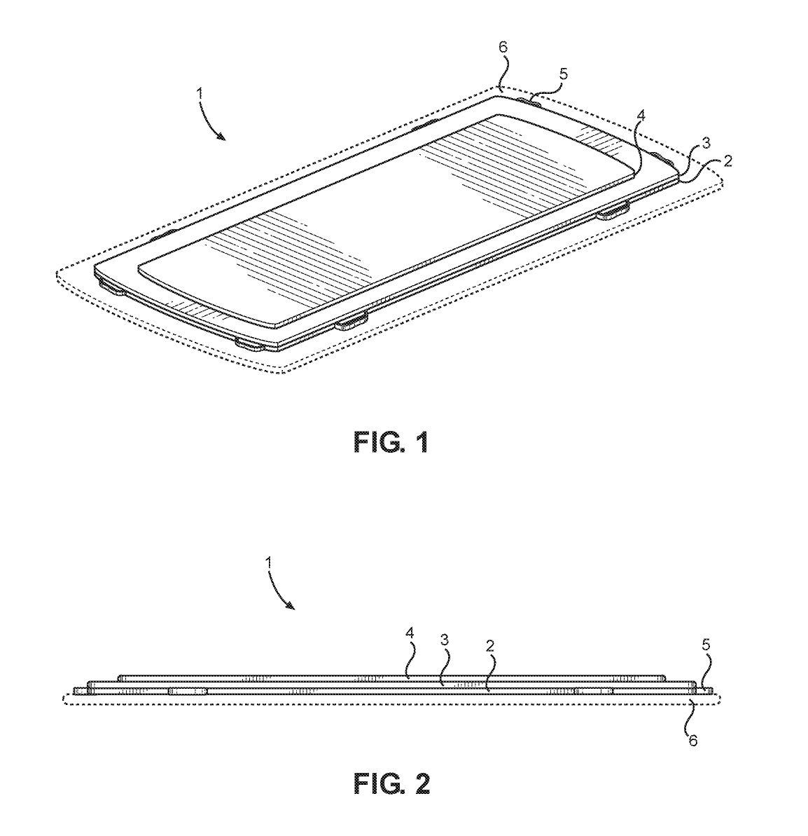

Referring now to FIGS. 1 and 2, there are depicted a perspective view of an exemplary embodiment of a mattress cover (FIG. 1) and a side perspective view of the exemplary embodiment of the mattress cover (FIG. 2). The mattress cover 1 comprises a mattress cover bottom layer 2, a mattress cover middle layer 3 disposed on an upper surface of the mattress cover bottom layer 2, and a mattress cover top layer 4 disposed on an upper surface of the mattress cover middle layer 3. The mattress cover bottom layer 2 is composed of a material that is durable and slippery. The mattress cover middle layer 3 is composed of a material that is moderately firm. The mattress cover top layer 4 is composed of a material that is durable and stain resistant.

The mattress cover top layer 4 has an upper surface that is in direct contact with a patient, a bottom surface that is connected to the upper surface of the mattress cover middle layer, and four vertical sides that define a perimeter of the mattress cover top layer 4. Dimensions of the perimeter of the mattress cover top layer 4 may be described in terms of a length and a width of the mattress cover top layer 4. The mattress cover top layer 4 is also adapted to be smooth and to provide comfort to the patient, and provides improved bed rest to the patient by adapting to a shape of the patient's body. The mattress cover top layer 4 is composed of a stain resistant and tough material that is easy to maintain, and together with the other layers, provides a smooth surface under the patient at all times. The mattress cover top layer 4 promotes and maintains skin integrity of the patient, and facilitates air and blood circulation, thereby preventing a formation of decubitus ulcers on the patient.

The upper surface of the mattress cover middle layer 3 is connected to the bottom surface of the mattress cover top layer 4, a bottom surface of the mattress cover middle layer 3 is connected to the upper surface of the mattress cover bottom layer 2, and the mattress cover middle layer 3 has four vertical sides that define a perimeter of the mattress cover top layer 4. Dimensions of the perimeter of the mattress cover middle layer 3 may be described in terms of a length and a width of the mattress cover middle layer 3. The mattress cover middle layer 3 may be composed of a foam type of material, such as a memory foam, or another material configured to adapt to the shape of the patient's body and maintain the smoothness of the mattress cover top layer 4. In one embodiment, the mattress cover middle layer 3 is two inches thick (i.e., a height of the mattress cover middle layer 3 is two inches). Generally, the mattress cover middle layer 3 is composed of a firm foam material that promotes comfort of the patient, ameliorates an effect of a weight of the patient on a skin contact surface of the patient, and importantly, promotes blood and air circulation. In one embodiment, the length of the mattress cover top layer 4 is less than the length of the mattress cover middle layer 3, and the width of the mattress cover top layer 4 is less than the width of the mattress cover middle layer 3. In this manner, the mattress cover 1 may be easily moved without disturbing the patient laying thereon.

The upper surface of the mattress cover bottom layer 2 is connected to the bottom surface of the mattress cover middle layer 3, a bottom surface of the mattress cover bottom layer 2 interacts with a surface 6 with minimal friction, and the mattress cover bottom layer 4 has four vertical sides that define a perimeter of the mattress cover bottom layer 2. The surface 6 may be any surface suitable for supporting the patient laying on the mattress cover 1, such as a bed sheet. The surface 6 may be composed of a cotton sateen detachable material that is fully elasticized and fade resistant, and may be both washable and replaceable.

Dimensions of the perimeter of the mattress cover bottom layer 2 may be described in terms of a length and a width of the mattress cover bottom layer 2. The minimal friction between the bottom surface of the mattress cover bottom layer 2 and the surface 6 enables a caretaker to easily move a patient resting on the mattress cover 1 between beds, from a bed to a procedure table, from a procedure table to a bed, or between any two surfaces, as needed. In one embodiment, the mattress cover bottom layer 2 comprises a plurality of handles 5, attached to a plurality of vertical sides thereof. In one embodiment, the mattress cover bottom layer 2 comprises four vertical sides, wherein each vertical side comprises two handles 5 attached thereto. In one embodiment, the length of the mattress cover bottom layer 2 is equal to the length of the mattress cover middle layer 3, and the width of the mattress cover bottom layer 2 is equal to the width of the mattress cover middle layer 3. In various embodiments, the mattress cover bottom layer 2 can sustain a weight of up to 400 pounds.

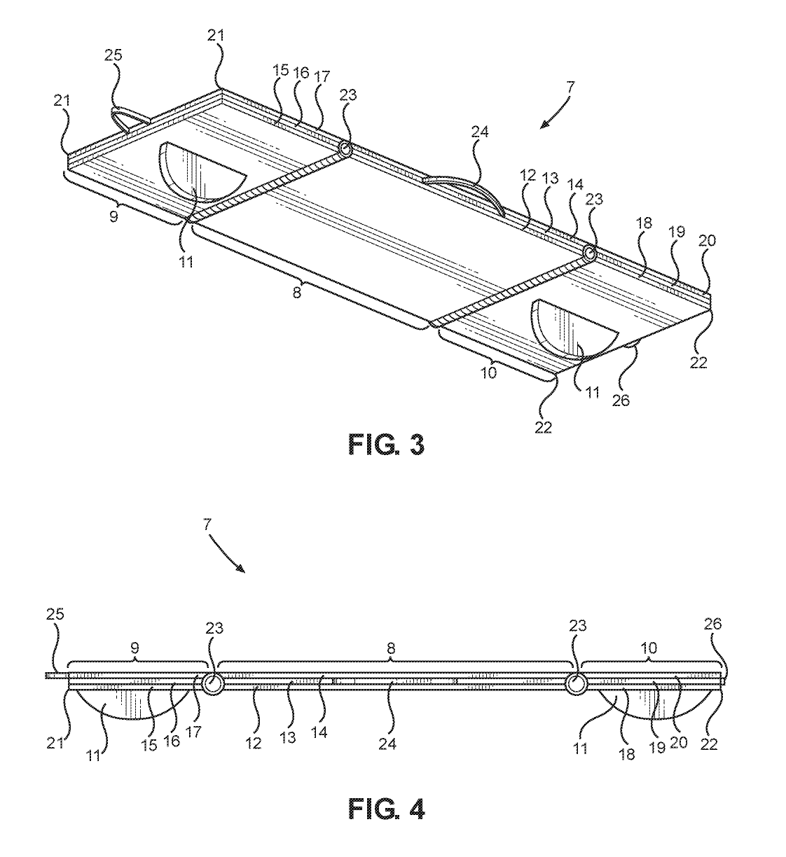

Referring now to FIGS. 3 and 4, there are depicted a perspective view of an exemplary embodiment of a transfer board (FIG. 3), and a side perspective view of the exemplary embodiment of the transfer board (FIG. 4). The transfer board 7 includes a main board 8, a first side board 9, and a second side board 10. The first side board 9 is connected to a first side of the main board, and the second side board 10 is connected to a second side of the main board, such that the first side of the main board is opposite to the second side of the main board. The transfer board 7 is composed of a material that is durable and slippery, and also includes at least one stabilizing fin 11 extending perpendicularly downward from a bottom side of the transfer board.

The main board 8, first side board 9, and second side board 10 comprise a main board upper layer 14, a first side board upper layer 17, and a second side board upper layer 20, respectively (collectively, the transfer board upper layers). Upper surfaces of the transfer board upper layers are in direct contact with either the patient, or with the bottom surface of the mattress cover bottom layer (see FIGS. 1, and 2) during use of the transfer board. A bottom surface of the main board upper layer 14 is connected to an upper surface of a main board middle layer 13. A bottom surface of the first side board upper layer 17 is connected to an upper surface of a first side board middle layer 16. A bottom surface of the second side board upper layer 20 is connected to an upper surface of a second side board middle layer 19. Each of the transfer board upper layers has four vertical sides that define a perimeter of the main board 8, the first side board 9, and the second side board 10.

Dimensions of the perimeter of the main board 8, the first side board 9, and the second side board 10 may be described in terms of a length and a width of the main board 8, the first side board 9, and the second side board 10, respectively. The transfer board upper layers are generally made of the same or a similar material as the mattress cover bottom layer (see FIGS. 1, and 2), thereby providing a low-friction interaction between the transfer board upper layers and the mattress cover bottom layer that facilitates transfer of the patient resting on the mattress cover from a first surface to a second surface. In various embodiments, the transfer board upper layers and the mattress cover bottom layer are made of a slippery, tough, and durable material. In various embodiments, the transfer board can sustain a weight of up to 400 pounds. In various embodiments, the transfer board upper layers are made of a durable and slippery material.

The main board 8, first side board 9, and second side board 10 comprise a main board middle layer 13, a first side board middle layer 16, and a second side board middle layer 19, respectively (collectively, the transfer board middle layers). As described above, upper surfaces of the transfer board middle layers are connected to the bottom surfaces of the transfer board upper layers. A bottom surface of the main board middle layer 13 is connected to an upper surface of a main board bottom layer 12. A bottom surface of the first side board middle layer 16 is connected to an upper surface of a first side board bottom layer 15. A bottom surface of the second side board middle layer 19 is connected to an upper surface of a second side board middle layer 18. The transfer board middle layers may be made of the same or a similar material as the mattress cover middle layer (see FIGS. 1, and 2), thereby providing comfort to the patient during transfer of the patient with the transfer board.

In various embodiments, the main board middle layer 13 comprises a handle 24 affixed to a vertical side of the main board middle layer 13. In various embodiments, the first side board middle layer 16 comprises an elastic band 25 affixed to a vertical side of the first side board middle layer 16 opposite the main board 8, and the second side board middle layer 19 comprises a button 26 affixed to a vertical side of the second side board middle layer 19 opposite the main board 8, wherein the elastic band 25 is configured to reversibly engage the button 26 to secure the transfer board in a closed position (e.g., when the first side board 9 and the second side board 10 are folded at pivots 23). In various embodiments, each pivot 23 may be a stainless hinge, an elastic band, a combination thereof, or one or more other suitable pivoting structures useful for adjusting an angle of the first side board 9 relative to the main board 8, and for adjusting an angle of the second side board 10 relative to the main board 8, thereby enabling a user to fold the transfer board 7 into a compact shape to prepare the transfer board 7 for storage when not in use. In various embodiments, the transfer board middle layers are made of a material that is moderately firm.

The main board 8, first side board 9, and second side board 10 comprise the main board bottom layer 12, the first side board bottom layer 15, and the second side board bottom layer 18, respectively (collectively, the transfer board bottom layers). As described above, upper surfaces of the transfer board bottom layers are connected to the bottom surfaces of the transfer board middle layers. A stabilizing fin 11 is attached to a bottom surface of the first side board bottom layer 15, such that the stabilizing fin 11 extends perpendicularly downward from the bottom surface of the first side board bottom layer 15. Additionally, a stabilizing fin 11 is attached to a bottom surface of the second side board bottom layer 18, such that the stabilizing fin 11 extends perpendicularly downward from the bottom surface of the second side board bottom layer 18. The stabilizing fins 11 are positioned in a gap between two surfaces, such as a space between a pair of adjacent beds, to prevent lateral movement or rotation of the transfer board 7 during transfer of the patient between the two surfaces. In various embodiments, the transfer board bottom layers are made of a material that has a rough texture. In one embodiment, the first side board corners 21 are angled downward, and the second side board corners 22 are angled downward. In this way, the rough texture of the transfer board bottom layers, combined with the downward angle of the first side board corners 21 and the second side board corners 22, provide a high degree of friction between the transfer board 7 and one or more surfaces on which it rests, such as two beds that are close together, thereby reducing a risk of the transfer board slipping or shifting during use.

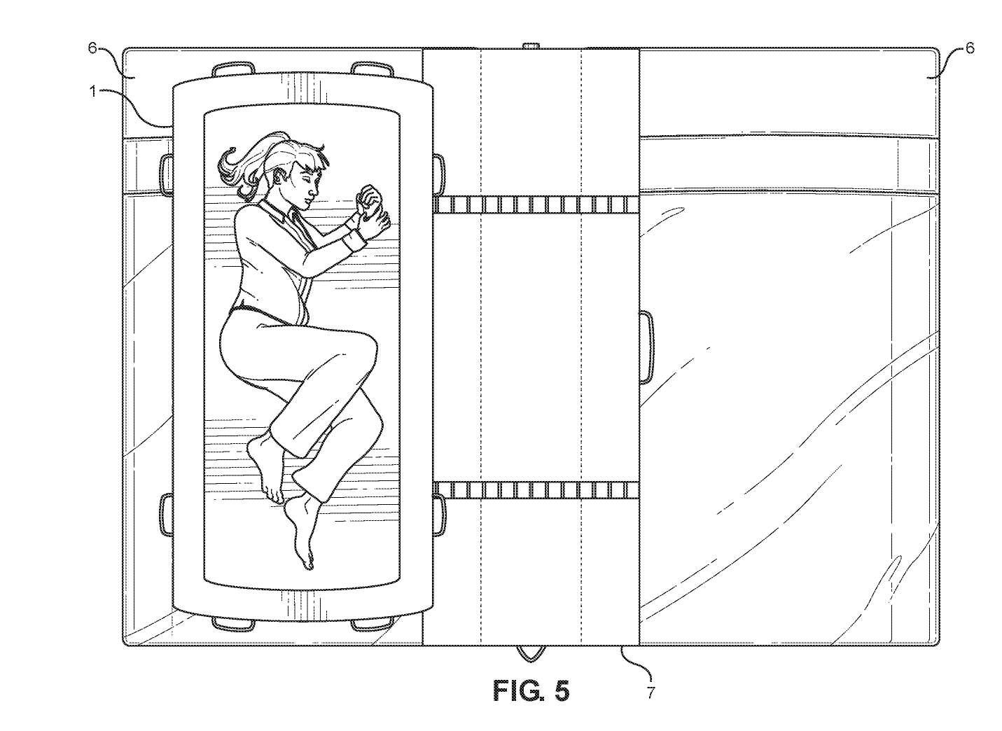

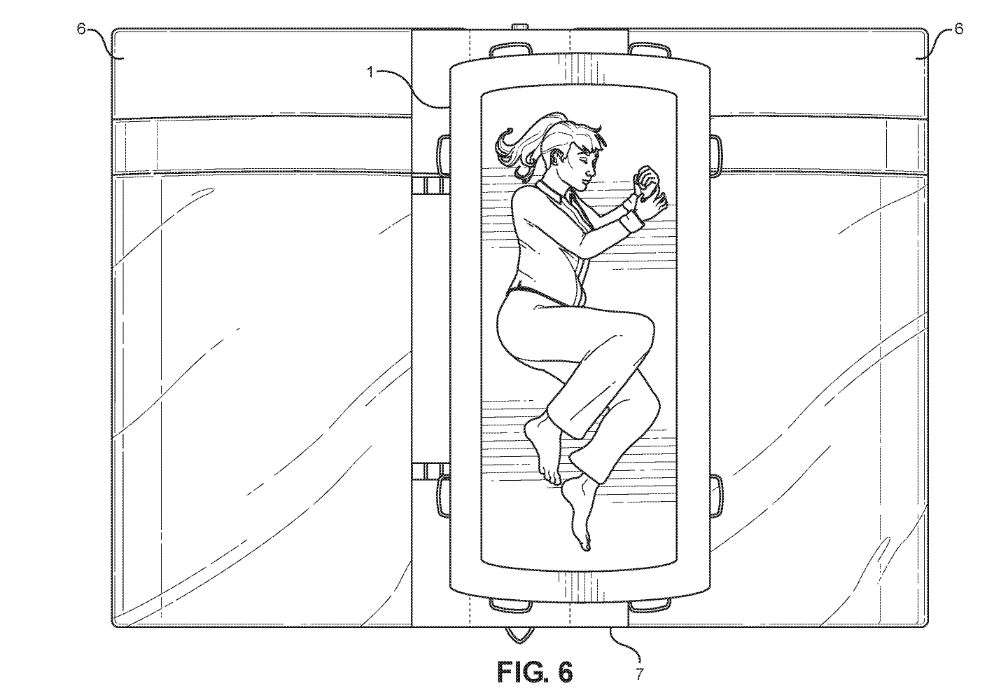

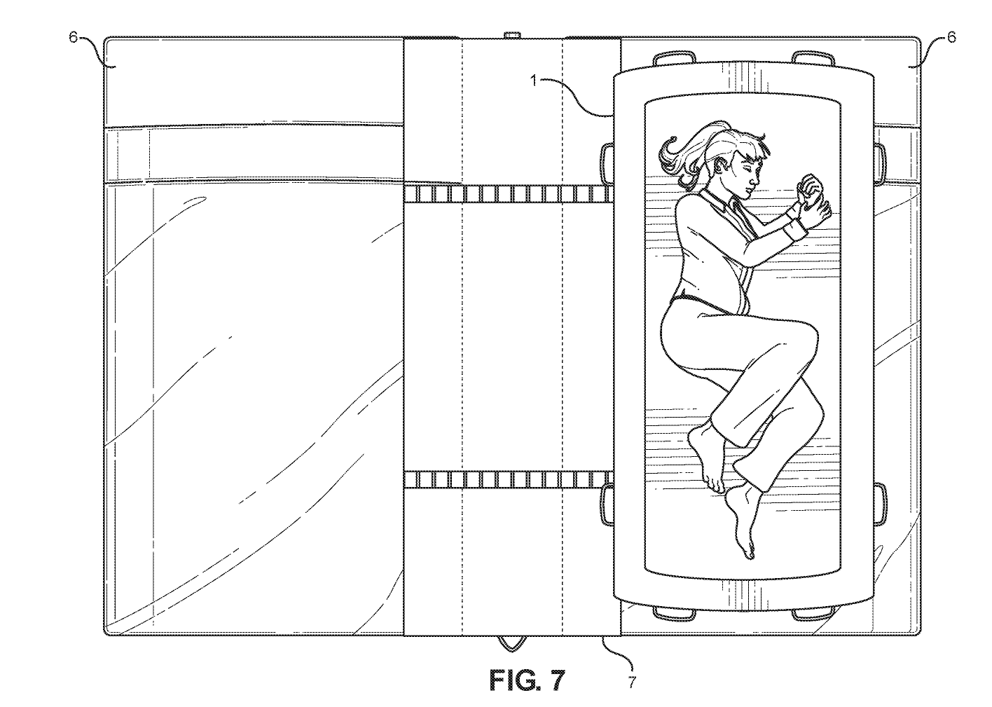

Referring now to FIGS. 5-7, there are depicted top perspective views of the exemplary embodiment of the mattress cover used in combination with the exemplary embodiment of the transfer board, showing a patient resting on the mattress cover, being transferred from a first surface (left bed) to a second surface (right bed) by sliding the mattress cover over the transfer board bridging the two beds. The figures depict positions of the patient before (FIG. 5), during (FIG. 6), and after (FIG. 7) transfer of the patient from the first surface (6, left) to the second surface (6, right).

The mattress cover 1 is configured to easily slide over the transfer board 7, thereby facilitating transfer of the patient from the first surface (6, left) to the second surface (6, right). This effectively reduces the risk of injury of caretakers during transfer of the patient between the surfaces. In some embodiments, the transfer board 7 is used without the mattress cover 1. In some embodiments, the mattress cover 1 is used without the transfer board 7. In the shown embodiment, the mattress cover 1 is used in combination with the transfer board 7, to maximize benefits of the present invention.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A bed rest system, comprising:
a mattress cover comprising a mattress cover bottom layer, a mattress cover middle layer disposed on an upper surface of the mattress cover bottom layer, and a mattress cover top layer disposed on an upper surface of the mattress cover middle layer;
wherein the mattress cover bottom layer is composed of a material that is durable and slippery;
wherein the mattress cover middle layer is composed of a material that is moderately firm;
wherein the mattress cover top layer is composed of a material that is durable and stain resistant.

2) The system of claim 1, wherein the mattress cover bottom layer comprises a plurality of handles, attached to a plurality of vertical sides thereof

3) The system of claim 2, wherein the mattress cover bottom layer comprises four vertical sides, wherein each vertical side comprises two handles attached thereto.

4) The system of claim 1, wherein a length of the mattress cover bottom layer is equal to a length of the mattress cover middle layer, and wherein a width of the mattress cover bottom layer is equal to a width of the mattress cover middle layer.

5) The system of claim 1, wherein a length of the mattress cover top layer is less than a length of the mattress cover middle layer, and wherein a width of the mattress cover top layer is less than a width of the mattress cover middle layer.

6) The system of claim 4, wherein a length of the mattress cover top layer is less than the length of the mattress cover middle layer, and wherein a width of the mattress cover top layer is less than the width of the mattress cover middle layer.

7) A bed rest system, comprising:
a transfer board comprising a main board, a first side board, and a second side board;
wherein the first side board is connected to a first side of the main board, and the second side board is connected to a second side of the main board, such that the first side of the main board is opposite to the second side of the main board;
wherein the transfer board is composed of a material that is durable and slippery;
wherein the transfer board includes at least one stabilizing fin extending perpendicularly from a bottom side of the transfer board.

8) The system of claim 7, wherein the main board comprises a main board bottom layer, a main board middle layer disposed on an upper surface of the main board bottom layer, and a main board top layer disposed on an upper surface of the main board middle layer;
wherein the first side board comprises a first side board bottom layer, a first side board middle layer disposed on an upper surface of the first side board bottom layer, and a first side board top layer disposed on an upper surface of the first side board middle layer;
wherein the second side board comprises a second side board bottom layer, a second side board middle layer disposed on an upper surface of the second side board bottom layer, and a second side board top layer disposed on an upper surface of the second side board middle layer.

9) The system of claim 8, wherein the main board bottom layer, the first side board bottom layer, and the second side board bottom layer each is composed of a material that has a rough texture;
wherein the main board middle layer, the first side board middle layer, and the second side board middle layer each is composed of a material that is moderately firm;
wherein the main board top layer, the first side board top layer, and the second side board top layer each is composed of the material that is durable and slippery.

10) The system of claim 7, wherein a side of the first side board distal from the main board includes two corners that are angled downward, and wherein a side of the second side board distal from the main board includes two corners that are angled downward.

11) The system of claim 7, wherein the first side board is connected to the first side of the main board by at least one selected from a group consisting of: a stainless hinge, and an elastic band, and wherein the second side board is connected to the second side of the main board by at least one selected from a group consisting of: a stainless hinge, and an elastic band.

12) The system of claim 7, wherein the first side board includes a first side board stabilizing fin extending perpendicularly downward from a bottom side of the first side board, and the second side board includes a second side board stabilizing fin extending perpendicularly downward from a bottom side of the second side board.

13) The system of claim 7, wherein the transfer board comprises a handle attached to a vertical side of the main board.

14) The system of claim 7, wherein the first side board comprises an elastic band attached to a side of the first side board distal from the main board, and wherein the second side board comprises a button attached to a side of the second side board distal from the main board, wherein the elastic band is configured to reversibly engage with the button to fold and secure the transfer board in a compact configuration for storage when not in use.

15) The system of claim 7, comprising:
a mattress cover comprising a mattress cover bottom layer, a mattress cover middle layer disposed on an upper surface of the mattress cover bottom layer, and a mattress cover top layer disposed on an upper surface of the mattress cover middle layer;
wherein the mattress cover bottom layer is composed of a material that is durable and slippery;
wherein the mattress cover middle layer is composed of a material that is moderately firm;
wherein the mattress cover top layer is composed of a material that is durable and stain resistant;
wherein the mattress cover is configured to easily slide on the transfer board.

16) The system of claim 15, wherein the mattress cover bottom layer comprises a plurality of handles, attached to a plurality of vertical sides thereof

17) The system of claim 16, wherein the mattress cover bottom layer comprises four vertical sides, wherein each vertical side comprises two handles attached thereto.

18) The system of claim 15, wherein a length of the mattress cover bottom layer is equal to a length of the mattress cover middle layer, and wherein a width of the mattress cover bottom layer is equal to a width of the mattress cover middle layer.

19) The system of claim 15, wherein a length of the mattress cover top layer is less than a length of the mattress cover middle layer, and wherein a width of the mattress cover top layer is less than a width of the mattress cover middle layer.

20) The system of claim 18, wherein a length of the mattress cover top layer is less than the length of the mattress cover middle layer, and wherein a width of the mattress cover top layer is less than the width of the mattress cover middle layer.
